(19) United States
(12) Patent Application Publication
(10) Pub. No.: US 2006/0209154 A1
(43) Pub. Date: Sep. 21, 2006

(54) Image Forming Apparatus Having Conveying Portion That Conveys Recording Medium Along Slanting Direction

(75) Inventors: Yasushi Okabe, Nagoya-shi, Aichi-ken (JP); Naoya Kamimura, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Mizuho-ku (JP)

(21) Appl. No.: 11/276,839

(22) Filed: Mar. 16, 2006

(30) Foreign Application Priority Data
Mar. 18, 2005 (JP) 2005079281

(51) Int. Cl. B41J 2/01

(52) U.S. Cl. 347/104

(57) ABSTRACT

A main casing has one side and another side opposite the one side. A cover is provided on the one side and is configured to open and close the one side. A conveying portion is supported on the cover inside the main casing for conveying a recording medium along a slanting direction slanting upward and away from the one side. A plurality of process units is arranged in the slanting direction on a side opposite the one side with respect to the conveying portion. The plurality of process units sequentially forms developer images on the recording medium conveyed by the conveying portion. A turning portion is disposed downstream of the conveying portion in a conveying direction of the recording medium. The turning portion turns the recording medium toward the one side, thereby discharging the recording medium.

### CROSS REFERENCE TO RELATED APPLICATIONS

This application claims priority from Japanese Patent Application No. 2005-079281 filed Mar. 18, 2005. The entire content of the priority application is incorporated herein by reference.

### TECHNICAL FIELD

The disclosure relates to an image forming apparatus, and more particularly to a tandem-type image forming apparatus.

### BACKGROUND

An image forming apparatus disclosed in Japanese Patent Application Publication No. 2002-166593 includes a cover disposed on a front surface of the image forming apparatus that can open and close thereon; a paper cassette provided in the image forming apparatus below the cover that can be pulled cut therefrom; a conveying belt disposed within the image forming apparatus for conveying paper supplied from the paper cassette from a position near the front surface in the lower section of the image forming apparatus toward the rear surface in the upper section of the image forming apparatus, four process units disposed on the upper side of the conveying belt and arranged along the conveying direction, and a scanning unit disposed on the front side surface.

Another image forming apparatus disclosed in Japanese Patent Application Publication No. 2003-186348 includes a paper cassette disposed in a bottom section of the image forming apparatus for accommodating paper and capable of being pulled out of the image forming apparatus through the front side surface thereof, a conveying belt for conveying paper from the paper cassette directly upward, four process units stacked vertically to confront the conveyor belt, and four scanning units corresponding to each of the process units.

### SUMMARY

However, when a paper jam occurs between the conveyor belt and process units in the image forming apparatus disclosed in Japanese Patent Application Publication No. 2002-166593, for example, the cover must be opened and the scanning unit and process units must be removed to resolve the jam. Hence, operability in such cases is poor. Further, moving the scanning unit at this time may shift the position at which laser light is irradiated onto the process units, thereby adversely affecting image formation.

In the image forming apparatus disclosed in Japanese Patent Application Publication No. 2003-186348, paper that has been supplied from the paper cassette and that has undergone image formation is ultimately discharged onto a discharge tray formed on the top surface of the image forming apparatus toward the rear side surface of the image forming apparatus, making the paper more difficult to retrieve. Paper becomes even more difficult to retrieve from the discharge tray when an original-reading device is provided above the discharge tray.

In view of the foregoing, it is an object of the invention to provide an image forming apparatus that facilitates retrieval of a recording medium that has been discharged from the image forming apparatus. Another object of the invention is to provide an image forming apparatus that facilitates a process for resolving paper jams.

In order to attain the above and other objects, the invention provides an image forming apparatus. The image forming apparatus includes a main casing, a cover, a conveying portion, a plurality of process units, and a turning portion. The main casing has one side and another side opposite the one side, when the main casing is disposed in an orientation in which the main casing is intended to be used. The cover is provided on the one side and is configured to open and close the one side. The conveying portion is supported on the cover inside the main casing for conveying a recording medium along a slanting direction slanting upward and away from the one side. The plurality of process units is arranged in the slanting direction on a side opposite the one side with respect to the conveying portion. The plurality of process units sequentially forms developer images on the recording medium conveyed by the conveying portion. The turning portion is disposed downstream of the conveying portion in a conveying direction of the recording medium. The turning portion turns the recording medium toward the one side, thereby discharging the recording medium.

According to another aspect, the invention provides an image forming apparatus. The image forming apparatus includes a main casing, a cover, a conveying portion, a plurality of process units, an original-reading device, and a discharging portion. The main casing has one side and another side opposite the one side, when the main casing is disposed in an orientation in which the main casing is intended to be used. The cover is provided on the one side and is configured to open and close the one side. The conveying portion is supported on the cover inside the main casing for conveying a recording medium along a slanting direction slanting upward and away from the one side. The plurality of process units is arranged in the slanting direction on a side opposite the one side with respect to the conveying portion. The plurality of process units sequentially forms developer images on the recording medium conveyed by the conveying portion. The original-reading device is disposed above the main casing between the one side and the another side The original-reading device reads an image from an original document. The discharging portion is disposed downstream of the conveying portion in a conveying direction of the recording medium. The discharging portion discharges the recording medium along the slanting direction toward the another side.

According to another aspect, the invention provides an image forming apparatus. The image forming apparatus includes a main casing, a conveying portion, a discharge tray, and a guiding portion. The main casing has a top surface and is formed with a discharge opening in the top surface, when the main casing is disposed in an orientation in which the main casing is intended to be used. The conveying portion is disposed inside the main casing. The conveying portion conveys a recording medium upward in a slanting direction through the discharge opening. The slanting direction is slanted with respect to a vertical direction. The discharge tray has a first receiving surface and a second receiving surface opposite the first receiving surface. The discharge tray is configured to be movable between a first orientation extending in the slanting direction for receiving, on the first receiving surface, the recording medium discharged through the discharge opening, and a second orientation for receiving, on the second receiving surface facing upward, the recording medium discharged through the discharge opening. The guiding portion allows the recording medium to be conveyed toward the first receiving surface when the discharge tray is in the first orientation, and guides the recording medium toward the second receiving surface when the discharge tray is in the second orientation.

### BRIEF DESCRIPTION OF THE DRAWINGS

Illustrative aspects in accordance with the invention will be described in detail with reference to the following figures wherein:

FIG. 1A is a cross-sectional view of a printer according to a first embodiment of the invention, when a cover is in a closed position;

FIG. 1B is an enlarged view showing part of a discharge unit as viewed from a direction indicated by an arrow IB in FIG. 1A;

FIG. 2 is a cross-sectional view of the printer in FIG. 1A, when the cover is in an open position;

FIG. 3 is a cross-sectional view of a printer according to a second embodiment of the invention, when a cover is in a closed position;

FIG. 4 is a cross-sectional view of the printer in FIG. 3, when the cover is in an open position;

FIG. 5A is a cross-sectional view of a printer according to a third embodiment of the invention, when a double-sided discharge tray is in a face-up orientation;

FIG. 5B is a simplified perspective view showing the printer in FIG. 5A;

FIG. 6 is a cross-sectional view of the printer in FIG. 5A, when the double-sided discharge tray is in a face-down orientation;

FIG. 7 is a perspective view of the double-sided discharge tray;

FIG. 8A is an explanatory diagram showing the printer in a face-up discharge mode according to the third embodiment;

FIG. 8B is an explanatory diagram showing the printer in a face-down discharge mode according to the third embodiment; and

FIG. 8C is an explanatory diagram showing the printer in a flatbed use mode according to the third embodiment.

### DETAILED DESCRIPTION

### First Embodiment

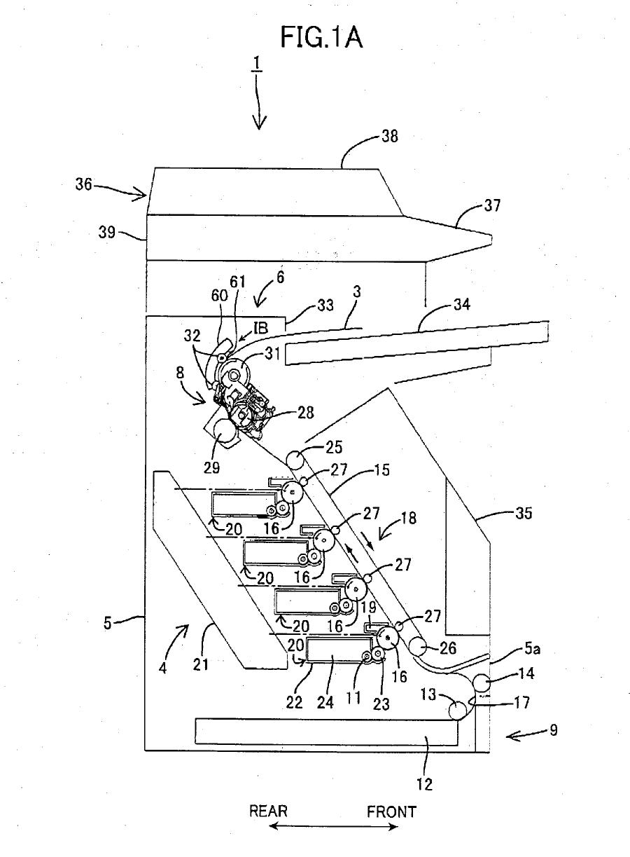

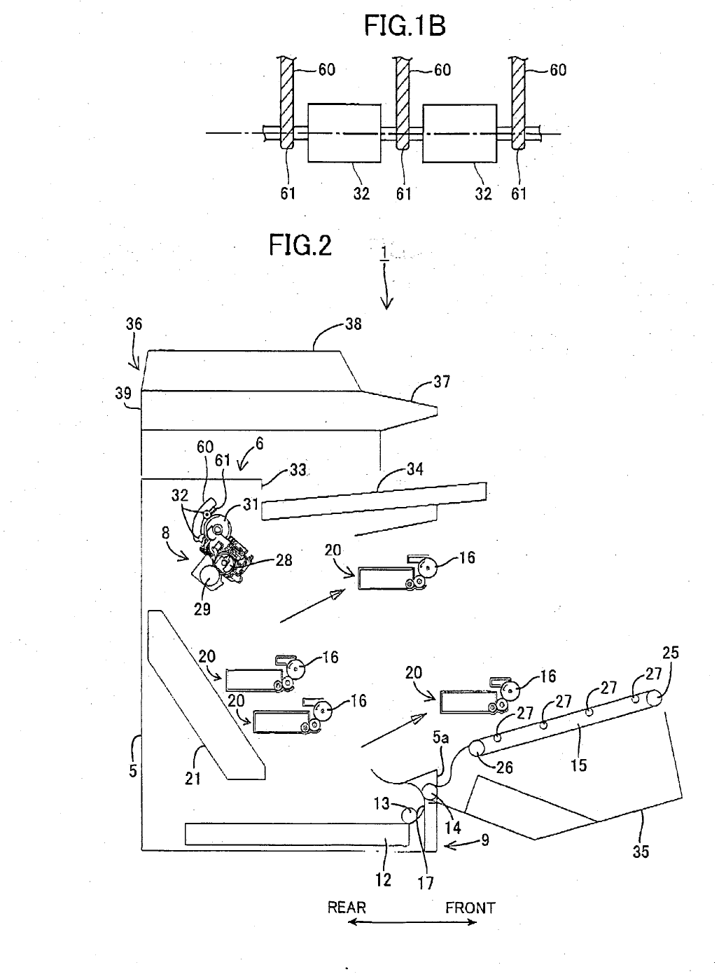

Next, an image forming apparatus according to a first embodiment of the invention will be described with reference to FIGS. 1A through 2.

1. General Structure of a Printer

FIGS. 1A and 2 are cross-sectional views showing the general structure of a printer 1 according to the first embodiment. In the following description, the right side of the printer 1 in FIGS. 1A and 2 will be called a front side, and the left side of the printer 1 in FIGS. 1A and 2 will be called a rear side. Note that the expressions “front”, “rear”, “upper”, and “lower” are used to define the various parts when the image forming apparatus is disposed in an orientation in which it is intended to be used.

As shown in FIGS. 1A and 2, the printer 1 is a vertical (diagonal) tandem-type color laser printer having four image forming units 20 described later that are disposed in a stepped arrangement (juxtaposed along a slanted direction to both the horizontal direction (i.e., mounting surface) and the vertical direction). The printer 1 includes a main casing 5 and, within the main casing 5, a paper supply unit 9 for supplying a recording paper 3 into the main casing 5, an image forming unit 4 for forming images on the recording paper 3 supplied from the paper supply unit 9, a discharge unit 6 for discharging the sheets of recording paper 3 after an image has been formed thereon. The main casing 5 has a front surface 5a on the front side.

(1) Paper Supply Unit

The paper supply unit 9 includes a paper tray 12 detachably mounted in a lower section of the main casing 5 and capable of being inserted into and removed from the main casing 5 through the front surface 5a side thereof; a feeding roller 13 disposed above a front end of the paper tray 12: and a conveying roller 14 disposed above the feeding roller 13 and downstream of the same with respect to a paper-conveying direction for conveying the recording paper 3.

When sheets of the recording paper 3 are stacked in the paper tray 12 and the feeding roller 13 rotates, the topmost sheet of the recording paper 3 is fed by the feeding roller 13 to the conveying rollers 14 one sheet at a time. A conveying belt 15 disposed downstream of the conveying rollers 14 subsequently conveys the recording paper 3 sequentially past photosensitive drums 16.

A U-shaped guide member 17 is provided in a section between the feeding roller 13 and the conveying belt 15 that includes the conveying roller 14. The recording paper 3 fed by the feeding roller 13 is initially conveyed in the frontward direction (rightward direction in FIGS. 1A and 2) and subsequently inverted and conveyed in the rearward direction by the U-shaped guide member 17. The recording paper 3 is then conveyed between the conveying belt 15 and the photosensitive drums 16 in sequence.

(2) Image Forming Unit

The image forming unit 4 disposed in the center region of the main casing 5 includes four image forming units 20 for forming images, a transfer unit 18 for transferring the images formed by each image forming unit 20 onto the recording paper 3, and a fixing unit 8 for fixing the images transferred onto the recording paper 3 to the surface of the recording paper 3 with heat and pressure. Since each of the image forming units 20 has the same structure, only components in the bottommost image forming unit 20 in FIGS. 1A and 2 have been numbered.

Each image forming unit 20 is configured of the photosensitive drum 16 and, around the periphery of the photosensitive drum 16, a charger 19 for charging the surface of the photosensitive drum 16, and a developer cartridge 22 for depositing toner on the surface of the photosensitive drum 16 to form a toner image thereon. Further, a scanning unit 21 is disposed on the rear side of the image forming units 20 for forming electrostatic latent images on the surfaces of the photosensitive drums 16.

The charger 19 is a positive-charging Scorotron charger having a charging wire formed of tungsten or the like from which a corona discharge is generated. The charger 19 functions to charge the entire surface of the photosensitive drum 16 with a uniform positive polarity.

The scanning unit 21 includes laser-generating units for generating laser beams, lenses, and the like (none of which components are shown in the drawings) for forming electrostatic latent images on the surfaces of the photosensitive drums 16. With this construction, the laser-generating units of the scanning unit 21 emit laser beams that are irradiated on the photosensitive drums 16 of all the image forming units 20 in a scanning motion for forming electrostatic latent images on the surfaces thereof.

The developer cartridge 22 includes a casing, within which are provided a toner hopper 24, a supply roller 11, and a developing roller 23. The toner hopper 24 is a space formed inside the casing of the developer cartridge 22. Each toner hopper 24 accommodates a developer of one of the colors yellow (Y), magenta (M), cyan (C), and black (K), for example.

The supply roller 11 is disposed at the front of the toner hopper 24 and includes a metal roller shaft covered by a roller portion that is formed of an electrically conductive sponge material. The supply roller 11 confronts and contacts the developing roller 23 at a nip position and is supported to be rotatable in a direction opposite the developing roller 23 at the nip position.

The developing roller 23 is rotatably disposed to the side of the supply roller 11 and confronts and contacts the supply roller 11. The developing roller 23 is configured of a metal roller shaft covered by a roller portion that is formed of a resilient material, such as an electrically conductive rubber material.

The transfer unit 18 is disposed in the main casing 5 so as to confront the photosensitive drums 16 on the opposite side of the developer cartridges 22. The transfer unit IS includes a drive roller 25, a follow roller 26, the conveying belt 15 looped around the drive roller 25 and follow roller 26, and the transfer rollers 27.

The follow roller 26 is disposed diagonally above the feeding roller 13 and diagonally below and forward (down and to the right in the drawings) of the photosensitive drum 16 in the image forming unit 20 farthest upstream in the paper-conveying direction of the recording paper 3. Note that the paper-conveying direction is a direction diagonally upward and to the left in the drawings. The drive roller 25 is disposed diagonally below and forward of the fixing unit 8 and above the photosensitive drum 16 in the image forming unit 20 farthest downstream in the paper-conveying direction.

The conveying belt 15 is looped over the drive roller 25 and follow roller 26 such that the outer surface of the conveying belt 15 confronts and contacts the photosensitive drum 16 in each image forming unit 20.

When the drive roller 25 is driven to rotate, the follow roller 26 follows the rotation of the drive roller 25. At this time, the conveying belt 15 looped around the drive roller 25 and follow roller 26 moves circularly in the clockwise direction in FIG. 1A (as indicated by the solid arrows in FIG. 1A) so that the outer surface of the conveying belt 15 moves in the same direction as the outer surfaces of the photosensitive drums 16 at the point of contact between the conveying belt 15 and the photosensitive drums 16.

The transfer rollers 27 are disposed inside the loop of the conveying belt 15 at positions confronting each of the photosensitive drums 16 via the conveying belt 15. The transfer roller 27 is configured of a metal roller shaft covered with a roller portion that is formed of a resilient member, such as an electrically conductive rubber material.

The transfer rollers 27 are capable of rotating in the clockwise direction in FIG. 1A so that the outer surfaces of the transfer rollers 27 move in the same direction as the conveying belt 15 at the point of contact therewith. During a transfer operation, a power supply applies a predetermined voltage through constant current control for producing an appropriate transfer bias between the transfer roller 27 and the photosensitive drum 16 for causing developer borne on each photosensitive drum 16 to migrate (transfer) to the recording paper 3.

The fixing unit 8 is disposed diagonally above and rearward of (up and to the left in the drawings) the image forming units 20 and the transfer unit 18, and downstream of the same in the paper-conveying direction. The fixing unit 8 includes a heating roller 28 and a pressure roller 29. The heating roller 28 is configured of a metal tube, the surface of which is coated with a release layer. The metal tube accommodates a halogen lamp that extends along the axis of the heating roller 28. The halogen lamp heats the surface of the heating roller 28 to a fixing temperature.

The pressure roller 29 is disposed in confrontation with the heating roller 28 for applying pressure thereto.

(3) Discharge Unit

The discharge unit 6 includes a first discharge roller 31, a plurality of second discharge rollers 32, and a plurality of guide ribs 60. The first discharge roller 31 is disposed adjacent to the fixing unit 8 and downstream of the heating roller 28 in the paper-conveying direction. The second discharge rollers 32 are smaller in diameter than the first discharge roller 31 and are disposed along the periphery of the first discharge roller 31. As shown in FIG. 1B, the second discharge rollers 32 are also arranged along the axial direction of the first discharge roller 31. As shown in FIG. 1B, the plurality of guide ribs 60 is arranged along the axial direction. As shown in FIGS. 1A and 1B, each guide rib 60 has a guide edge 61 that substantially follows the periphery of the first discharge roller 31 with a predetermined space therebetween. A rear end of each guide rib 60 (the end opposite from the guide edge 61) is supported on the main casing 5 via a supporting structure not shown in the drawings.

After the heating roller 28 and pressure roller 29 have fixed an image on the recording paper 3, the first and second discharge rollers 31 and 32 pinch and convey the recording paper 3 along the periphery of the first discharge roller 31. At this time, the guide ribs 60 (more specifically, the guide edges 61) guide the recording paper 3 along the periphery of the first discharge roller 31. In this way, the conveying direction is turned from an upward and rearward slanting direction to a forward direction. The method of turning the conveying direction is not limited to the configuration including rollers and guide ribs, but may be configured of only a guiding wall (without rollers) for guiding the recording paper 3 in a turning direction.

After turning directions, the recording paper 3 is discharged through a discharge opening 33 formed in the top surface of the main casing 5 onto a discharge tray 34 disposed on the top surface of the main casing 5. At this time, the recording paper 3 is discharged in a face-up orientation in which the printed surface is facing upward.

(4) Scanning Device

The printer 1 in the present embodiment is also provided with a flatbed-type scanning device (original-reading device) 36 disposed above the main casing 5. Hence, the printer 1 employs an in-body discharge system in which the printed recording paper 3 is retrieved from the discharge tray 34 at a position between the main casing 5 and the scanning device 36.

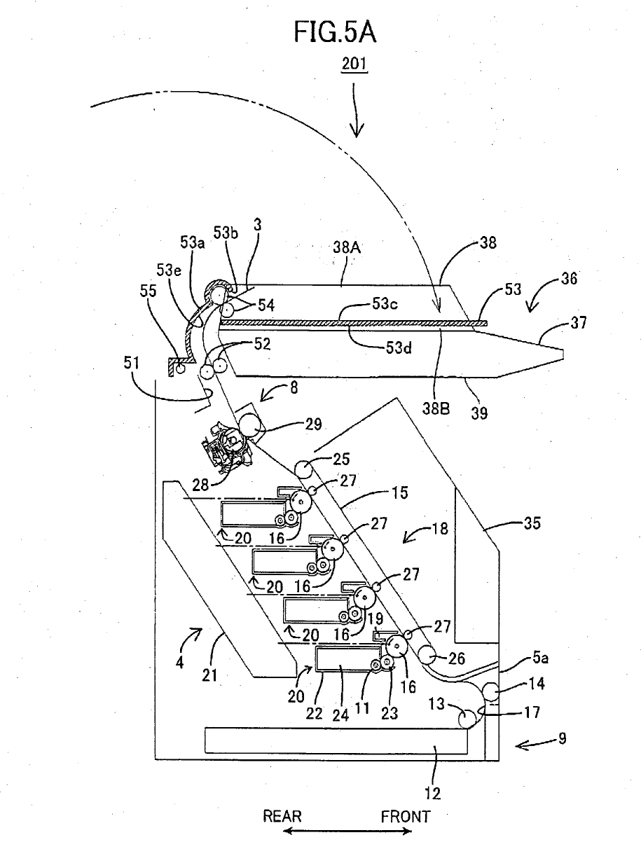

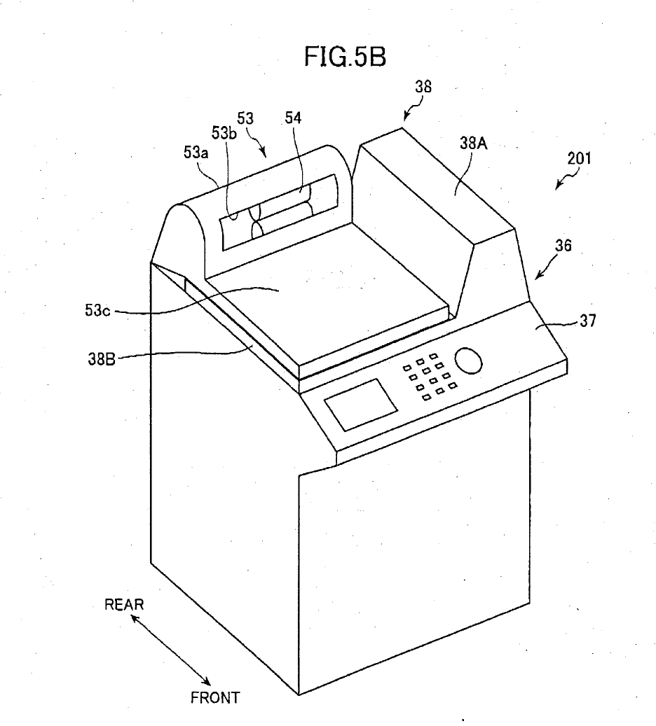

While a detailed description of the scanning device 36 will not be given here, the scanning device 36 includes a flatbed 39 and an original cover 38. A control panel 37 is disposed on the upper front surface of the flatbed 39 and has a touch panel for executing operations. The original cover 38 is disposed on the top of the flatbed 39. The original cover 38 includes an automatic document feeder (ADF) on the right side thereof (the far side in FIG. 1A; the ADF is disposed in an ADF portion 38A shown in FIG. 5B). The ADF includes an original document tray (not shown) from which an original is fed one sheet at a time into the scanning device 36. The sheets of the original pass over an image sensor (not shown) disposed in the flatbed 39 for reading an image from the original. Image data for the original read by the scanning device 36 is transferred to a control circuit (not shown) in the main casing 5 provided for controlling the image forming unit 4 and the like.

2. Transfer Unit, Front Cover, Etc.

As shown in FIG. 1A, the four image forming units 20 are stacked in an oblique direction so as to be gradually shifted rearward from the bottommost image forming unit 20 to the topmost image forming unit 20. In other words, the higher the position of the image forming unit 20, the farther the image forming unit 20 is separated from the front surface 5a. The conveying belt 15 in the transfer unit 18 is disposed along the front of the four image forming units 20 in contact with the photosensitive drums 16.

With this construction, the feeding roller 13 and the like feed each sheet of recording paper 3 in the paper tray 12 first in a forward direction and then in a diagonal direction upward and toward the rear. From this point, the conveying belt 15 continues to convey the recording paper 3 diagonally upward, while each image forming unit 20 sequentially forms an image on the surface of the recording paper 3 confronting the photosensitive drum 16 (the surface facing down to the left in FIG. 1A).

After the recording paper 3 passes between the heating roller 28 and pressure roller 29, the discharge unit 6 (the first and second discharge rollers 31 and 32 and the guide ribs 60) turns the conveying direction of the recording paper 3 from the upward and rearward slanting direction to a forward direction, and discharge the recording paper 3 through the discharge opening 33 onto the discharge tray 34. Hence, the printer 1 of the present embodiment employs a Z-path conveying system for conveying the recording paper 3 back and forth through the image forming unit 20 along a path shaped like a “Z”.

As shown in FIG. 1A, the transfer unit 18 is supported on the inner side of a front cover 35. The front cover 35 is pivotally supported about a lower end thereof on the front surface 5a of the main casing 5. Hence, by opening the front cover 35, the conveying belt 15 can be separated from all of the photosensitive drums 16 at once, as shown in FIG. 2. Subsequently, each of the image forming units 20 can be individually removed.

3. Effects of the First Embodiment

In the first embodiment described above, the conveying belt 15 can be simultaneously separated from all photosensitive drums 16 by opening the front cover 35 thereby facilitating the removal of jammed recording paper 3, for example, when a paper jam occurs between the conveying belt 15 and the photosensitive drums 16. Moreover, the scanning unit 21 is fixedly disposed on the rear of the image forming units 20 and need not be moved, thereby ensuring that the positions at which the laser beams irradiate the photosensitive drums 16 do not shift, since the scanning unit 21 requires high positioning accuracy.

Further, the recording paper 3 is ultimately discharged in a forward direction by the discharge unit 6 (the first and second discharge rollers 31 and 32 and the guide ribs 60). Hence, the user can conveniently retrieve the discharged recording paper 3 from the front side, which is the same side from which the image forming units 20 are removed.

In the first embodiment, the flatbed-type scanning device 36 is disposed above the main casing 5 to construct an in-body discharge type printer with the discharge tray 34 provided in a space between the scanning device 36 and the main casing 5, the space being open on the front side. Therefore, it is particularly useful to retrieve the discharged recording paper 3 from the front side.

### Second Embodiment

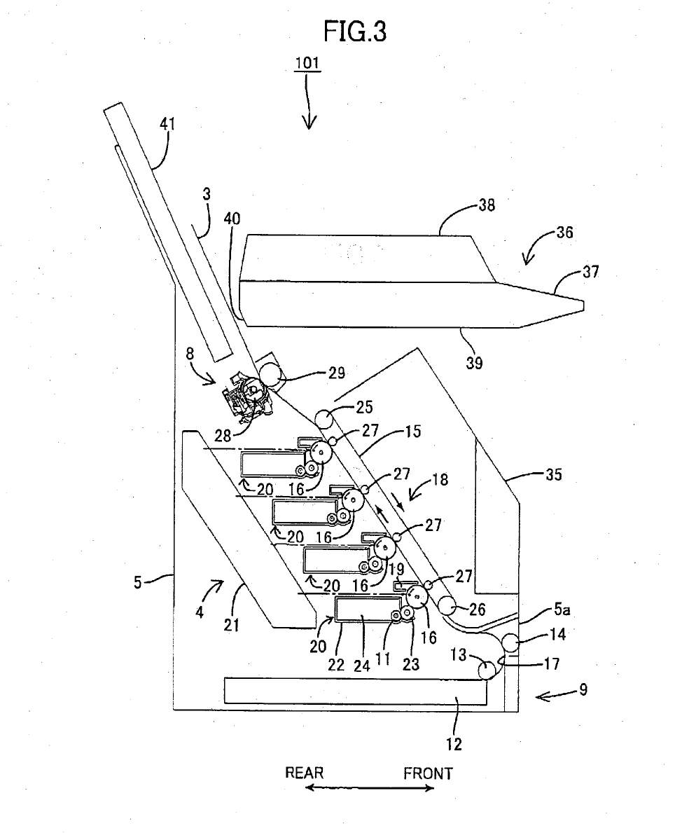

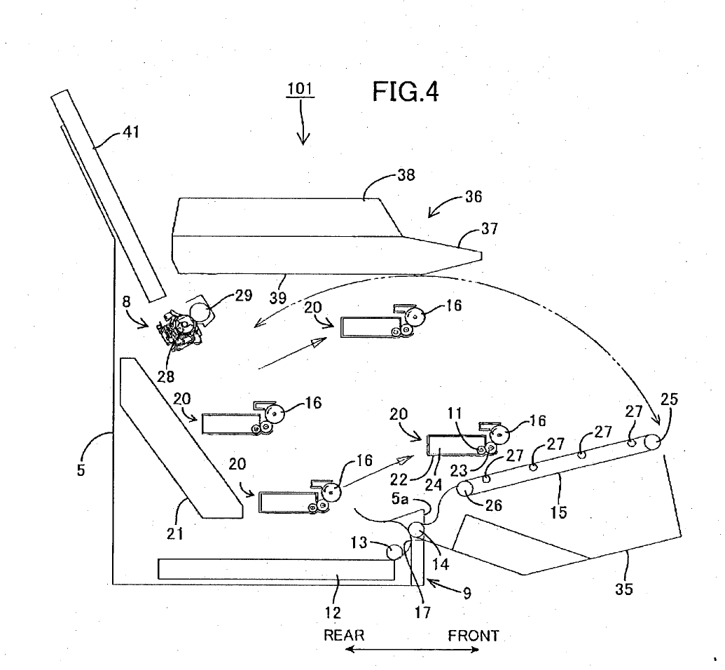

FIGS. 3 and 4 show a printer 101 according to a second embodiment. The second embodiment differs from the first embodiment described above in the structure of the discharge unit 6. Since the remaining structure is identical to that described in the first embodiment, like parts and components are designated with the same reference numerals to avoid duplicating description.

As shown in FIG. 3, unlike the printer 1 according to the first embodiment, the printer 101 according to the second embodiment does not include the first and second discharge rollers 31 and 32. Therefore, after the recording paper 3 is conveyed diagonally upward and to the rear between the conveying belt 15 and photosensitive drums 16 and passes through the heating roller 28 and pressure roller 29, the heating roller 28 and pressure roller 29 continue to convey the recording paper 3 in the same slanting direction.

Accordingly, the recording paper 3 is discharged through a discharge opening 40 formed on the rear side of the scanning device 36. More specifically, the scanning device 36 is disposed farther forward than in the first embodiment on the top of the main casing 5, allowing the discharge opening 40 to be formed in the top of the main casing 5 rearward of the scanning device 36.

A discharge tray 41 is provided in communication with the discharge opening 40. The recording paper 3 discharged through the discharge opening 40 in an upward and rearward slanting direction is deposited on the discharge tray 41.

At this time, the recording paper 3 is discharged face-down, that is, with the image formation surface facing the discharge tray 41. Therefore, when image formation is performed with document data extending over a plurality of pages in a predetermined order, for example, the order can be preserved when the printed sheets are discharged onto the discharge tray 41.

Further, since the printed recording paper 3 is discharged substantially upward from the rear side of the scanning device 36, the user can retrieve the recording paper 3 more easily than when the recording paper 3 is discharged in a directly rearward direction. Also, the amount that the recording paper 3 is bent can be reduced when the recording paper 3 is conveyed toward the discharge tray 41.

Further, in the second embodiment, it is not necessary to provide a discharge space between the scanning device 36 and the main casing 5, enabling the scanning device 36 to be positioned lower, as shown in FIG. 4, as long as the scanning device 36 does not interfere with an opening and closing path of the front cover 35 (indicated by a two-dot chain line in FIG. 4). In other words, the printer 101 in the second embodiment can be further reduced in height than the printer 1 in the first embodiment.

### Third Embodiment

FIGS. 5A through 8C show a printer 201 according to a third embodiment. The third embodiment differs from the first embodiment described above in the structure of the discharge unit 6. Since the remaining structure is identical to that described in the first embodiment, like parts and components are designated with the same reference numerals to avoid duplicating description.

The printer 201 according to the third embodiment includes a double-sided discharge tray 53 that can be tilted to select either a face-up discharge or a face-down discharge. As in the second embodiment, the printer 201 according to the third embodiment does not include the first and second discharge rollers 31 and 32 and guide ribs 60. Further, after the recording paper 3 conveyed diagonally upward and rearward between the conveying belt 15 and photosensitive drums 16 passes between the heating roller 28 and pressure roller 29, the heating roller 28 and pressure roller 29 continue to convey the recording paper 3 in the same slanting direction and is discharged through a discharge opening 51 provided behind the scanning device 36. As in the second embodiment, the scanning device 36 in the third embodiment is also disposed farther forward on the top of the main casing 5 so that the discharge opening 51 can be formed in the top of the main casing 5 and in the rear of the scanning device 36. A pair of discharge rollers 52 is disposed in the discharge opening 51. When driven to rotate, the discharge rollers 52 discharge the recording paper 3 farther outward through the discharge opening 51.

As shown in FIG. 53, the original cover 38 includes an ADF portion 38A having the ADF and a plate-like portion 38B formed thinner than the ADF portion 38A. Note that FIG. 5B is a simplified perspective view showing the printer 201. In FIG. 5B, the double-sided discharge tray 53, the original cover 38, and the like are shown in a simplified manner.

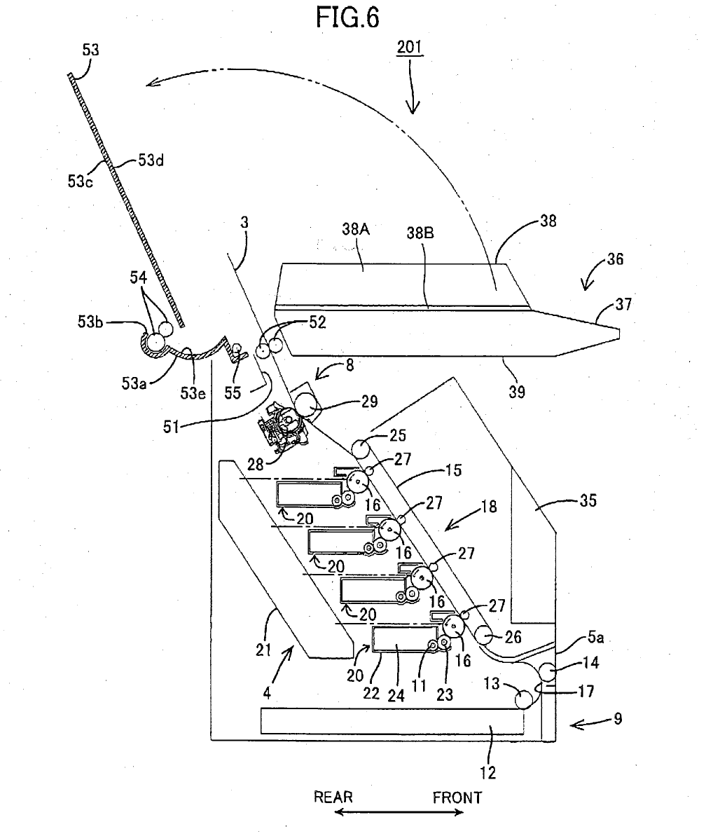

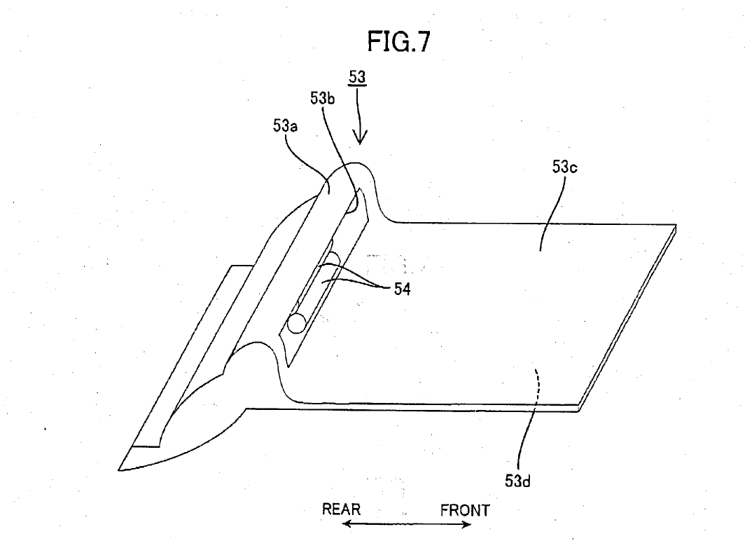

The double-sided discharge tray 53 is provided above the discharge opening 51. As shown in FIG. 7, the double-sided discharge tray 53 has an overall rectangular plate shape. A portion of the double-sided discharge tray 53 near the rear end (the left side in FIG. 7) swells upward, forming an expanded part 53a. The rear side of the expanded part 53a is curved in an arc (see FIGS. 5A and 6). A through-hole 53b having a width slightly greater than the width of the recording paper 3 is formed in the front surface of the expanded part 53a. A pair of discharge rollers 54 is disposed just inside the through-hole 53b.

As shown in FIGS. 5A and 6, the lower rear portion of the expanded part 53a is pivotally supported about a rotational shaft 55 at a position rearward of the discharge opening 51. Accordingly, the double-sided discharge tray 53 can pivotally move between a face-up orientation shown in FIG. 5A, whereby a surface 53c of the double-sided discharge tray 53 (the top surface in FIG. 7) lies flat over the scanning device 36, and a face-down orientation shown in FIG. 6, whereby the double-sided discharge tray 53 is erected from a position rearward of the scanning device 36 with an underside surface 53d (bottom surface in FIG. 7) facing diagonally upward.

For example, when forming images on a single sheet of paper, the double-sided discharge tray 53 is placed in the face-up orientation shown in FIGS. 5A and 5B. In the face-up orientation, the double-sided discharge tray 53 lies on the plate portion 38B of the original cover 38. In this state, the recording paper 3 conveyed through the discharge opening 51 follows an arc-shaped surface of an inner rear wall 53e to be guided from the upward and rearward slanting direction to a forward direction. Subsequently, the discharge rollers 54 convey the recording paper 3 forward through the through-hole 53b and discharge the recording paper 3 onto the surface 53c of the double-sided discharge tray 53.

When it is desirable to form images on a plurality of sheets in a predetermined page order, the double-sided discharge tray 53 is placed in the face-down orientation shown in FIG. 6. In this state, the recording paper 3 can continue in the slanting direction upward and to the rear after passing through the discharge opening 51 and car be discharged on the underside surface 53d of the double-sided discharge tray 53. At this time, the inner rear wall 53e of the double-sided discharge tray 53 functions to receive a plurality of sheets of the discharged recording paper 3. When the double-sided discharge tray 53 is in the face-up orientation (described above) shown in FIGS. 5A and 5B, the discharge rollers 54 are engaged with a drive gear of the scanning device 36, for example, and receive a driving force therefrom. However, when the double-sided discharge tray 53 is in the face-down orientation in FIG. 6, the discharge rollers 54 may be disengaged so as not to receive the driving force.

In the third embodiment, it is possible to switch easily between the face-down discharge and the face-up discharge simply by pivotally moving the double-sided discharge tray 53. Further, it is possible to reduce the number of required parts by integrally forming the double-sided discharge tray 53 of a single material (such as synthetic resin) that includes the tray portion for receiving the recording paper 3 and a guide portion (such as the inner rear wall 53e) for guiding the recording paper 3 when the double-sided discharge tray 53 is in the face-up orientation.

FIGS. 6A through 8C are explanatory diagrams showing various modes of the printer 201.

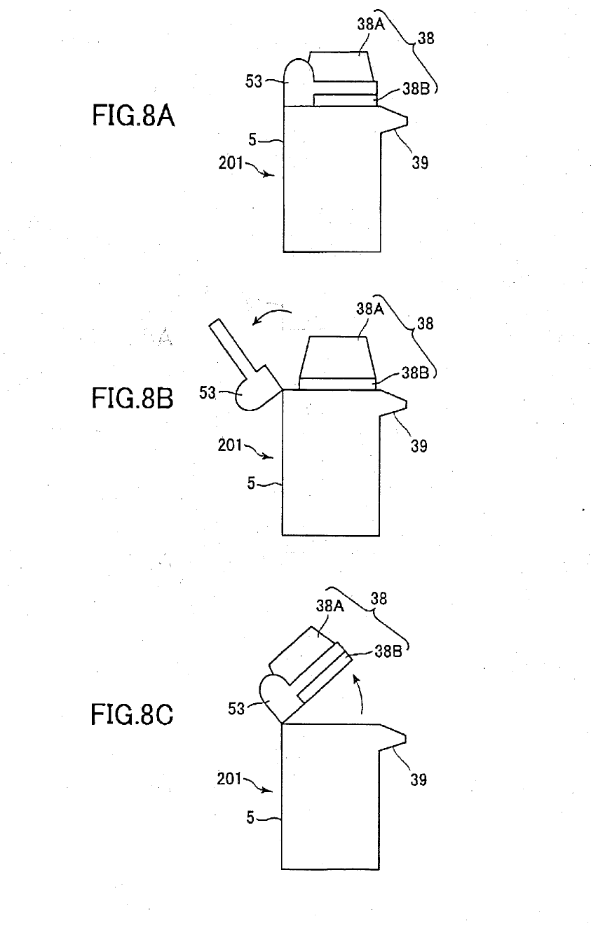

FIG. 8A shows the printer 201 in a face-up discharge mode which corresponds to FIGS. 5A and 5B. In the face-up discharge mode, both of the original cover 38 and the double-sided discharge tray 53 are positioned on the main casing 5.

FIG. 8B shows the printer 201 in a face-down discharge mode which corresponds to FIG. 6. In the face-down discharge mode, the original cover 38 is positioned on the main casing 5. However, the double-sided discharge tray 53 is pivotally moved toward the rear by an angle of greater than 90 degrees.

FIG. 8C shows the printer 201 in a flatbed use mode in which both of the original cover 38 and the double-sided discharge tray 53 are pivotally moved from the position of FIG. 8A. In the flatbed use mode, it is possible to place an original document on the flatbed 39 and to read (scan) an image on the original document.

<Modifications>

While the invention has been described in detail with reference to the above aspects thereof, it would be apparent to those skilled in the art that various changes and modifications may be made therein without departing from the spirit of the invention.

(1) For example, in the first embodiment described above, the paper tray 12 is disposed in the bottom section of the main casing 5 (below the conveying belt 15 and image forming units 20), and the recording paper 3 accommodated in the main casing 5 is conveyed back and forth through the printer 1 along a Z-shaped path. However, the printer 1 according to the present embodiment is not limited to this conveying path. For example, an insertion hole may be formed in the front surface 5a of the printer 1, and a manual feed tray or paper cassette may be disposed on the front side, so that the recording paper 3 may be inserted through the insertion hole to be conveyed along the conveying belt 15. This construction may also be applied to the second and third embodiments.

(2) The printer 201 in the third embodiment is capable of switching between a face-down discharge and a face-up discharge by pivotally moving the double-sided discharge tray 53. However, the printer 201 may instead be provided with a path switching mechanism capable of switching the conveying path for the recording paper 3 after the recording paper 3 passes through the fixing unit 8 between a face-down path and a face-up path.

(3) In the above-described embodiments, the scanning device 36 is provided on the printer 1, 101, and 201. However, the scanning device 36 need not be provided.

(4) In the above-described embodiments, the printers 1, 101, and 201 are described as examples of the image forming apparatus. However, the image forming apparatus also includes other apparatuses such as a facsimile apparatus; and a multifunction apparatus having various functions such as a printer function and a scanner function.

(5) Further, in the above-described embodiments, the recording paper 3 is used as an example of the recording medium. However, a plastic recording medium such as a transparency sheet may also be used as the recording medium.

What is claimed is:

1. An image forming apparatus comprising:
a main casing having one side and another side opposite the one side, when the main casing is disposed in an orientation in which the main casing is intended to be used;
a cover provided on the one side and configured to open and close the one side;
a conveying portion supported on the cover inside the main casing for conveying a recording medium along a slanting direction slanting upward and away from the one side;
a plurality of process units arranged in the slanting direction on a side opposite the one side with respect to the conveying portion, the plurality of process units sequentially forming developer images on the recording medium conveyed by the conveying portion; and
a turning portion disposed downstream of the conveying portion in a conveying direction of the recording medium, the turning portion turning the recording medium toward the one side, thereby discharging the recording medium.

2. The image forming apparatus according to claim 1, further comprising:
a non-turning portion disposed downstream of the conveying portion in the conveying direction, the non-turning portion discharging the recording medium along the slanting direction, allowing the discharged recording medium to be positioned above the another side; and
a selecting portion that selects whether the recording medium is discharged with the turning portion or with the non-turning portion.

3. The image forming apparatus according to claim 2, further comprising:
a discharge tray having a first receiving surface and a second receiving surface opposite the first receiving surface, the discharge tray supporting the recording medium conveyed by the conveying portion and discharged from the main casing, the discharge tray being configured to be movable between: a first orientation for receiving the recording medium on the first receiving surface that extends in the slanting direction and that faces slantingly upward; and a second orientation for receiving the recording medium on the second receiving surface that faces upward; and
a guiding portion that allows the recording medium to be conveyed toward the first receiving surface when the discharge tray is in the first orientation, and that guides the recording medium toward the second receiving surface when the discharge tray is in the second orientation.

4. The image forming apparatus according to claim 3, wherein, when the discharge tray is in the first orientation, the recording medium is discharged in a face-down orientation in which an image formation surface of the recording medium faces downward.

5. The image forming apparatus according to claim 3, wherein, when the discharge tray is in the second orientation, the recording medium is discharged in a face-up orientation in which an image formation surface of the recording medium faces upward.

6. The image forming apparatus according to claim 3, wherein the discharge tray and the guiding portion are integrally formed of a single member.

7. The image forming apparatus according to claim 3, further comprising an original-reading device disposed above the main casing for reading an image from an original document, wherein the discharge tray is positioned above the original-reading device when the discharge tray is in the second orientation.

8. The image forming apparatus according to claim 3, wherein the guiding portion has an arc-shaped surface that guides the recording medium toward the second receiving surface.

9. The image forming apparatus according to claim 1, further comprising an original-reading device disposed above the main casing for reading an image from an original document, wherein the recording medium is discharged between the main casing and the original-reading device when the recording medium is discharged by the turning portion.

10. The image forming apparatus according to claim 1, wherein the turning portion comprises:
a first roller;
a second roller having a smaller diameter than the first roller and disposed at a periphery of the first roller; and
a guide rib having a guide edge that substantially follows the periphery of the first roller with a predetermined space therebetween.

11. An image forming apparatus comprising.
a main casing having one side and another side opposite the one side, when the main casing is disposed in an orientation in which the main casing is intended to be used;
a cover provided on the one side and configured to open and close the one side;
a conveying portion supported on the cover inside the main casing for conveying a recording medium along a slanting direction slanting upward and away from the one side;
a plurality of process units arranged in the slanting direction on a side opposite the one side with respect to the conveying portion, the plurality of process units sequentially forming developer images on the recording medium conveyed by the conveying portion;
an original-reading device disposed above the main casing between the one side and the another side, the original-reading device reading an image from an original document; and
a discharging portion disposed downstream of the conveying portion in a conveying direction of the recording medium, the discharging portion discharging the recording medium along the slanting direction toward the another side.

12. The image forming apparatus according to claim 11, wherein the discharging portion comprises a discharge opening through which the recording medium is discharged, the discharge opening being formed on the another side of the original-reading device.

13. An image forming apparatus comprising:
a main casing having a top surface and formed with a discharge opening in the top surface, when the main casing is disposed in an orientation in which the main casing is intended to be used;
a conveying portion disposed inside the main casing, the conveying portion conveying a recording medium upward in a slanting direction through the discharge opening, the slanting direction being slanted with respect to a vertical direction;
a discharge tray having a first receiving surface and a second receiving surface opposite the firs receiving surface, the discharge tray being configured to be movable between: a first orientation extending in the slanting direction for receiving, on the first receiving surface, the recording medium discharged through the discharge opening; and a second orientation for receiving, on the second receiving surface facing upward, the recording medium discharged through the discharge opening; and
a guiding portion that allows the recording medium to be conveyed toward the first receiving surface when the discharge tray is in the first orientation, and that guides the recording medium toward the second receiving surface when the discharge tray is in the second orientation.

14. The image forming apparatus according to claim 13, wherein the discharge tray and the guiding portion are integrally formed of a single member.

15. The image forming apparatus according to claim 13, further comprising an original-reading device disposed above the main casing for reading an image from an original document, wherein the discharge tray is positioned above the original-reading device when the discharge tray is in the second orientation.

16. The image forming apparatus according to claim 13, wherein the guiding portion has an arc-shaped surface that guides the recording medium toward the second receiving surface.
